(19) United States
(12) Patent Application Publication
(10) Pub. No.: US 2014/0111317 A1
(43) Pub. Date: Apr. 24, 2014

(54) Remote Control Device for Model Helicopter

(71) Applicant: Anping Shen, Shenzhen (CN)

(72) Inventor: Anping Shen, Shenzhen (CN)

(73) Assignee: SHENZHEN SHEN'S TONGCHUANG AERONAUTIC MODEL CO., LTD., Shenzhen, Guangdong (CN)

(21) Appl. No.: 13/575,607

(22) PCT Filed: Sep. 21, 2011
(86) PCT No.: PCT/CN11/01601

§ 371 Date: Jul. 26, 2012

(30) Foreign Application Priority Data
Aug. 29, 2011 (CN) 201120318154.7

(51) Int. Cl. A63H 30/04; G08C 17/02

(52) U.S. Cl. CPC A63H 30/04; G08C 17/02
USPC 340/12.22

(57) ABSTRACT

Disclosed in the invention is a parameter adjusting device of a transmitter of a remote control helicopter model and the invention aims to solve the technical problems of disassembling and assembling the parameter adjusting device at will, improving the flexibility of the parameter adjusting device and reducing the user's later upgrade cost. The technical solutions are adopted in the invention: a parameter adjusting device of the transmitter of the remote control helicopter-model comprises the transmitter and the parameter adjusting device arranged on the transmitter, wherein the parameter adjusting device is connected with the transmitter by a detachable structure. Compared with the prior technology, the parameter adjusting device is made into a detachable independent model, thus the user's later upgrade cost is reduced, the data exchange is performed between the parameter adjusting device and the transmitter via a connecting line, the structure is simple and the user playable property is improved.

### BACKGROUND OF THE PRESENT INVENTION

1. Field of Invention

The present invention relates to a model helicopter, and more particularly to a control device for the model helicopter.

2. Description of Related Arts

Referring to FIG. 1, a conventional remote control device for a model helicopter comprises a control circuit board, a display, a control panel comprising a plurality of control buttons, and a data exchange device. A user of the conventional remote control device may control the operational parameters of the model helicopter, such as throttle control and moving direction, through controlling the control buttons and observing the display of the remote control device. For this type of conventional remote control device, the entire device forms an integral structure and all the electrical components are connected to the control circuit board. This implies that the control panel and the various electrical components are very hard to replace or move. As a result, some conventional remote control devices are designed to control moving directions, while others, are more sophisticatedly designed to control may operational parameters in addition to moving directions. However, once a remote control device is manufactured, it is almost impossible for a simple remote control device (i.e. those controlling only moving directions) to be upgraded to a more sophisticated remote control device, which is capable of also controlling the various operational parameters of the model helicopter. However, the selling price for these sophisticated remote control devices are very high, ad this impose great financial burden to causal players of model helicopter. Moreover, when a player initially bought a simple remote control device (i.e. controlling moving direction only), it is very hard, if not impossible, for him or her to upgrade the existing remote control device upgrade to a more sophisticated one. The only feasible way is for him or her to buy a new set of remote control device, or even a new set of model helicopter.

### SUMMARY OF THE PRESENT INVENTION

The invention is advantageous in that it provides a remote control device for a model helicopter, which comprises a main control unit and a parameter adjustment unit detachably attached on the main control unit so as to enhance flexibility of the parameter adjustment unit and minimize the cost of owning a remote control device on the part of the user.

According to the present invention, the foregoing and other objects and advantages are attained by providing a remote control device for a model helicopter, comprising a main control unit, and a parameter adjustment unit detachably attached on the main control unit.

The parameter adjustment unit comprises a LCD display module and a printed circuit board, wherein the LCD display module is electrically connected to the printed circuit board.

The LCD display module comprises a LCD screen protective frame, an upper supporting frame, a LCD screen, a lower supporting frame, a front frame member, and a rear frame member, wherein the printed circuit board is provided between the front frame member and the rear frame member, wherein the lower supporting frame is provided on a top surface of the front frame member, wherein the LCD screen is provided in the lower supporting frame, wherein the upper supporting frame is provided on the LCD screen protective frame, while the LCD screen protective frame is connected on the front frame member and the upper supporting frame.

The front frame member further has a controlling knob and a plurality of control buttons, wherein the controlling knob is electrically connected to a connection head of the printed circuit board, wherein the control buttons are electrically connected to a fine-adjustment switch of the printed circuit board.

The printed circuit board comprises a data port electrically connected to the connection slot of the main control unit.

The main control unit and the parameter adjustment unit are detachably connected with each other through a clip structure.

The parameter adjustment unit has a plurality of first slots indently formed on side edges thereof respectively, wherein the main control unit further has a plurality of positioning ridges for detachably connecting to the parameter adjustment unit.

The first slots are peripherally formed along the two side edges of the front frame member respectively.

Moreover, the front frame member further has a second slot transversely formed in the corresponding first slot.

The main control unit further comprises a locking latch provided thereon and is aligned with the second slot.

When compared with conventional arts, the present invention allows the user to upgrade a pre-existing main control unit by attaching the parameter adjustment unit thereonto. This enables the user to save costs and enhance the flexibility in owning the model helicopter and the corresponding remote control device.

### BRIEF DESCRIPTION OF THE DRAWINGS

FIG. 1 is a perspective view of a remote control device according to a preferred embodiment of the present invention.

FIG. 2 is a structural schematic diagram of a remote control device according to the above preferred embodiment of the present invention.

FIG. 3 is a first schematic diagram of a parameter adjustment unit of the remote control device according to the above preferred embodiment of the present invention.

FIG. 4 is a second schematic diagram of the parameter adjustment unit of the remote control device according to the above preferred embodiment of the present invention.

FIG. 5 is an exploded perspective view of the parameter adjustment unit of the remote control device according to the above preferred embodiment of the present invention.

FIG. 6 is a schematic diagram of a rear cover of the remote control device according to the above preferred embodiment of the present invention.

FIG. 7 is a schematic diagram of a control panel of the remote control device according to the above preferred embodiment of the present invention.

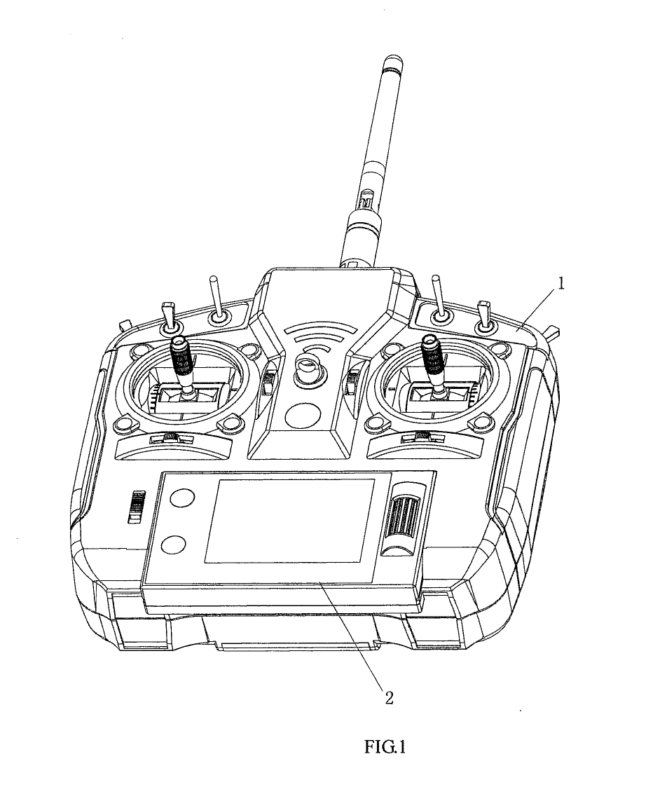

### DETAILED DESCRIPTION OF THE PREFERRED EMBODIMENT

The preferred embodiment of the present invention is fully elaborated below. Referring to 1 of the drawings, a remote control device for a model helicopter according to a preferred embodiment of the present invention is illustrated, in which the remote control device comprises a main control unit 1 and a parameter adjustment unit 2, wherein the parameter adjustment unit 2 is detachably attached on the main control unit 1.

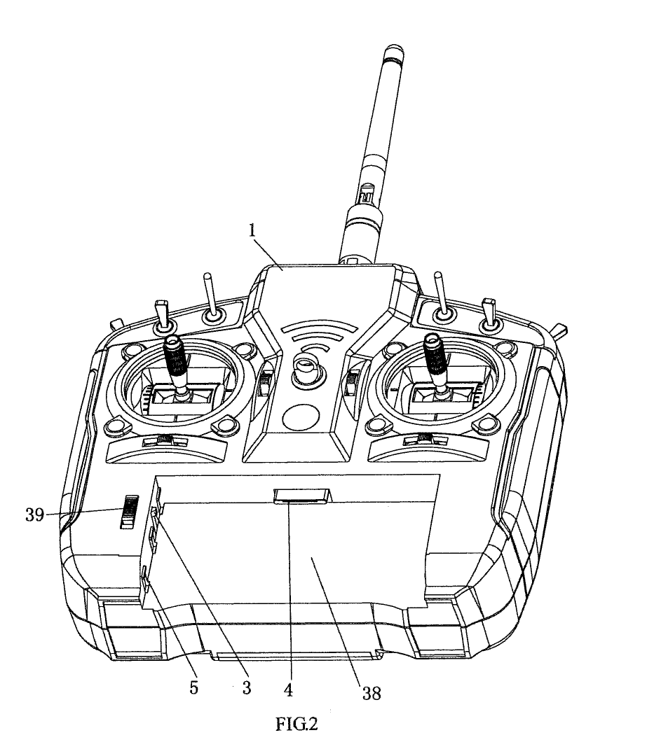

Referring to FIG. 2 of the drawings, it illustrates a structural schematic diagram of the remote control device of the present invention. The main control unit 1 has an attachment slot 38 formed at a lower portion thereof for detachably accommodating the parameter adjustment unit 2, wherein the parameter adjustment unit 2 is arranged to be received in the attachment slot 38 from a bottom side thereof. The parameter adjustment unit 2 utilizes a clip structure for detachably attaching to the main control unit 1. More specifically, the main control unit 1 further has a connection slot 4 formed on a top edge portion of the attachment slot 38, a plurality of positioning ridges 5 spacedly formed on two side walls of the attachment slot 38, a locking latch 3 movably provided on a side wall of the attachment slot 38, and a locking switch 39 connected to the locking latch 3 and is provided on a top surface of the main control unit 1, in such a manner that the locking switch 39 is arranged to drive the locking latch 3 to move in the attachment slot 38 for selectively retracting from the attachment slot 38 so as to unlock the parameter adjustment unit 2 with respect to the main control unit 1. As such, the parameter adjustment unit 2 is capable of being detached from the main control unit 1. Moreover, the parameter adjustment unit 2 has a plurality of first slots 8 indently formed on side edges thereof respectively.

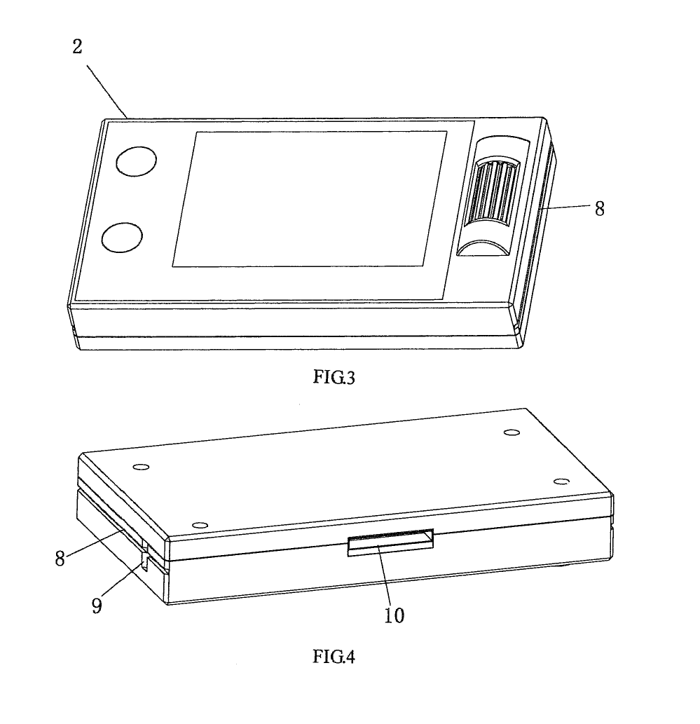

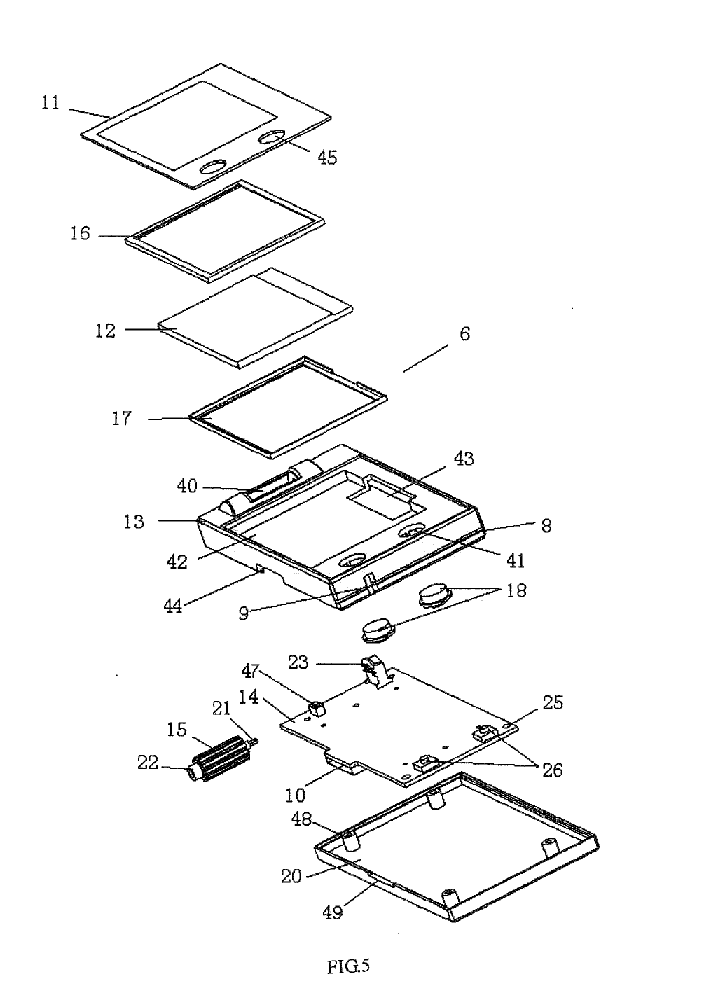

Referring to FIG. 3 to FIG. 4 of the drawings, the remote control device further comprises a LCD display module 6 and a printed circuit board (PCB) 14, wherein the LCD display module 6 is electrically mounted on the printed circuit board (PCB) 14.

The LCD display module 6 has a cubic appearance, and comprises a LCD protective frame 11, an upper supporting frame 16, a LCD screen 12, a lower supporting frame 17, a front frame member 13, and a rear frame member 20.

The first slots 8 are indently formed along two side edges of the front frame member 13, which has a second slot 9 indently and transversely formed on a side wall of the corresponding first slot 8. Moreover, the front frame member 13 further has a securing slot 40 indently formed thereon, and has a plurality of first control slots 41 spacedly formed thereon at a position which is opposite to the securing slot 40. The front frame member 13 further has a LCD slot 42 formed between the first control slots 41 and the securing slot 40, and a transmission cable slot 43 formed in the LCD slot 42 for allowing data cables to pass therebetween. Thus, the printed circuit board (PCB) 14 and the LCD display module 6 can be connected through data cables which pass through the transmission cable slot 43. Moreover, the front frame member 13 further has a first data connecting slot 44 formed thereon. The main control unit 1 further comprises a plurality of control buttons 18 provided in the first control slots 41 respectively, and a controlling knob 15 rotatably mounted in the securing slot 40.

The lower supporting frame 17 is mounted in the LCD slot 42, and wherein the LCD screen 12, which is connected to the printed circuit board 14, is mounted in a top portion of the lower supporting frame 17, wherein the upper supporting frame 16 is overlappedly mounted on top of the LCD screen 12, wherein the LCD protective frame 11 is mounted on the upper supporting frame 16. The LCD protective frame 11 further has a plurality of second control slots 45, wherein the control buttons 18 are received in the second control slots 45.

The printed circuit board 14 comprises a data port 10 provided on a top portion thereof, and a connection head 23, wherein the data port 10 is arranged to electrically connected to the connection slot 4. Moreover, the controlling knob 15 is arranged to be connected to the connection head 23 through a first pivot 21 penetrating through a pivot slot 28 provided in the securing slot 40. Furthermore, the controlling knob 15 further comprises a second pivot 22 connected to a support stand 47 provided on the printed circuit board 14. The main control unit 1 further comprises a fine-adjustment switch 26, whereas the printed circuit board 14 has a plurality of holes 25 formed on four corners portion thereof respectively.

The rear frame member 20 comprises a plurality of first connecting pins 48 spacedly formed thereon and is aligned with the holes 25 of the printed circuit board 14 respectively. Moreover, the rear frame member 20 further comprises a second data connecting slot 49 formed thereon and is aligned with the first data connecting slot 44, wherein the data port 10 is accommodated between the first data connecting slot 44 and the second data connecting slot 49.

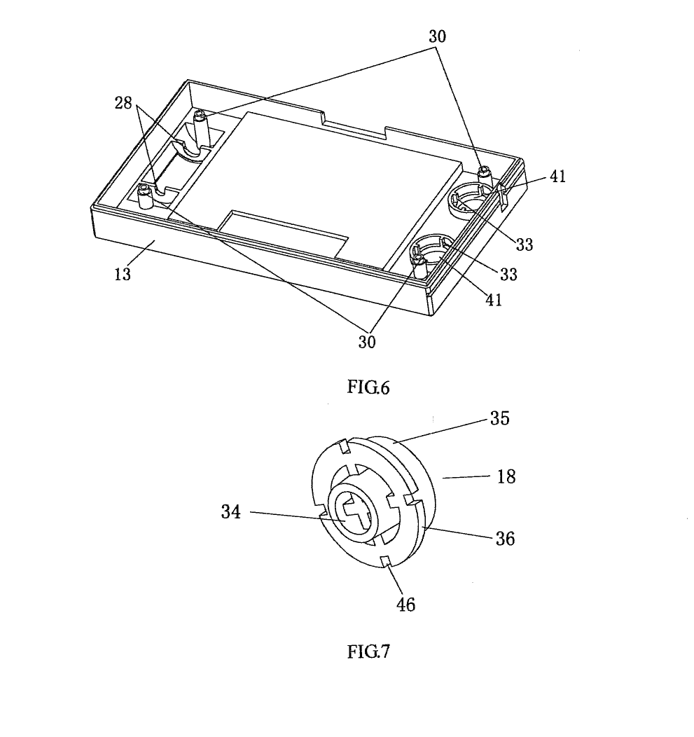

Referring to FIG. 6 of the drawings, the front frame member 13 further comprises a plurality of second connecting pins 48 spacedly formed thereon and is aligned with the holes 25 of the printed circuit board 14, wherein a diameter of each of the second connecting pins 48 is substantially the same as that of the corresponding hole 25. Moreover, each of the first control slots 41 has a guiding member 33 received therein, while the securing slot 40 has a plurality of pivot slots 28 formed therein.

Referring to FIG. 7 of the drawings, each of the control buttons 18 is preferably embodied as having a circular cross section, wherein each of the control buttons 18 comprises a contact surface 35, an actuating member 36, and a central through hole 34, wherein the contact surface 35 is provided on the actuating member 36, and the central through hole 34 is provided on the actuating member 36. The actuating member 36 has an indention slot 46 formed thereon, wherein the control button 18 is arranged to receive in the corresponding first control slot 41 of the front supporting member 13, wherein the indention slot 46 is arranged to engage with the corresponding guiding member 33 and prevents the control button 18 from rotating. Furthermore, the central through hole 34 is formed on the fine-adjustment switch 26.

The remote control device operates as follows: the LCD display module 6 is arranged to connect to the connection slot 4. When the remote control device is switched on, the LCD screen 12 is arranged to display an interactive menu for indicating the various operational parameters of the model helicopter. A user of the present invention may press on the control buttons 18 and the controlling knob 15 for controlling the operational parameters of the model helicopter.

The remote control device of the present invention is an independent device for transmitting command signals to the model helicopter. The first slots 8 and the positioning ridges 5 of the LCD display module 6 are arranged to facilitate convenient and rapid attachment and detachment of the parameter adjustment unit 2. The parameter adjustment unit 2 can be locked and unlocked through the second slots 9 and the locking latch 3. Moreover, the data port 10 of the parameter adjustment unit 2 is electrically connected to the connection slot 4 so as to facilitate data transmission between the main control unit 1 and the parameter adjustment unit 2. As an independent module, the parameter adjustment unit 2 can act as an upgrade module of a regular main control unit 1, so that a player may choose to buy either one of the main control unit 1 and the parameter adjustment unit 2, or both of them as a model helicopter set. Even if the user chooses to initially purchase the main control unit 1, he or she may upgrade his or her to system by additionally purchasing the parameter adjustment unit 2. This avoids the situation where the user has to purchase an entirely new set of model helicopter, and is therefore economically desirable on the part of the player.

What is claimed is:

1. A remote control device for a model helicopter, comprising a main control unit, and a parameter adjustment unit detachably attached on said main control unit.

2. The remote control device, as recited in claim 1, wherein said parameter adjustment unit comprises a LCD display module and a printed circuit board, wherein said LCD display module is electrically connected to said printed circuit board.

3. The remote control device, as recited in claim 2, wherein said LCD display module comprises a LCD screen protective frame, an upper supporting frame, a LCD screen, a lower supporting frame, a front frame member, and a rear frame member, wherein said printed circuit board is provided between said front frame member and said rear frame member, wherein said lower supporting frame is provided on a top surface of said front frame member, wherein said LCD screen is provided in said lower supporting frame, wherein said upper supporting frame is provided on said LCD screen protective frame, while said LCD screen protective frame is connected on said front frame member and said upper supporting frame.

4. The remote control device, as recited in claim 3, wherein said front frame member further has a controlling knob and a plurality of control buttons, wherein said controlling knob is electrically connected to a connection head of said printed circuit board, wherein said control buttons are electrically connected to a fine-adjustment switch of said printed circuit board.

5. The remote control device, as recited in claim 4, wherein said printed circuit board comprises a data port electrically connected to said connection slot of said main control unit.

6. The remote control device, as recited in claim 5, wherein said main control unit and said parameter adjustment unit are detachably connected with each other through a clip structure.

7. The remote control device, as recited in claim 6, wherein said parameter adjustment unit has a plurality of first slots indently formed on side edges thereof respectively, wherein said main control unit further has a plurality of positioning ridges for detachably connecting to said parameter adjustment unit.

8. The remote control device, as recited in claim 7, wherein said first slots are peripherally formed along said two side edges of said front frame member respectively.

9. The remote control device, as recited in claim 8, wherein said front frame member further has a second slot transversely formed in said corresponding first slot.

10. The remote control device, as recited in claim 9, wherein said main control unit further comprises a locking latch provided thereon and is aligned with said second slot.
